(19) United States
(12) Patent Application Publication
(10) Pub. No.: US 2019/0012600 A1
(43) Pub. Date: Jan. 10, 2019

(54) A METHOD OF OPTIMAL SCHEDULING AND REAL-TIME CONTROL FOR AN xMANAGEMENT SYSTEM

(71) Applicant: NEC Corporation, Minato-ku, Tokyo (JP)

(72) Inventors: Alexander VIEHWEIDER, Tokyo (JP); Shantanu CHAKRABORTY, Tokyo (JP)

(73) Assignee: NEC Corporation, Minato-ku, Tokyo (JP)

(21) Appl. No.: 15/739,835

(22) PCT Filed: Jul. 8, 2015
(86) PCT No.: PCT/JP2015/003443

§ 371 Date: Dec. 26, 2017

(51) Int. Cl. G06N 5/00; G06N 7/08; G06Q 10/04; G06Q 10/06; G06K 9/62

(52) U.S. Cl. CPC G06N 5/003; G06N 7/08; G06K 9/6272; G06Q 10/06313; G06Q 10/04

(57) ABSTRACT

One of the features of the invented method is that it adds to the scenario selection criteria the impact on the control command of the single scenarios. If necessary it takes also into account the performance achieved during single scenario optimization and combines scenario describing space information with single scenario optimization results space information. By using reduced scenarios (subset) an overall optimization procedure based on the subset can be established. If results are not satisfactory from the performance or constraints point of view a new iteration is initiated.

### TECHNICAL FIELD

The present invention relates to a method of optimal scheduling and real-time control for an xManagement System (xMS).

### BACKGROUND ART

The existing patented technology considers especially methods for risk management in multiple parameter physical systems (ex. Patent Literature 1, U.S. Pat. No. 5,930,762) and methods for financial portfolio management (ex. Patent Literature 2, U.S. Pat. No. 5,148,365), model predictive control methods and process control. Scenario based optimization and constraint treatment is used in this published or patented technologies and researches.

### CITATION LIST

### Patent Literature

[PTL 1]: U.S. Pat. No. 5,148,365
[PTL 2]: U.S. Pat. No. 5,930,762
[PTL 3]: U.S. Pat. No. 7,337,022
[PTL 4]: U.S. Pat. No. 6,792,399

### Non Patent Literature

[NPL 1]: G. C. Calafiore, L. Fagiano, “Robust Model Predictive Control via Scenario Optimization”, IEEE Transaction on Automatic Control, Vol. 58, Issue 1, January 2013, pp. 219-224
[NPL 2]: Xiaojing Zhang, Georg Schildbach, David Sturzenegger, and Manfred Morari, “Scenario-Based MPC for Energy-Efficient Building Climate Control under Weather and Occupancy Uncertainty”, European Control Conference, 2013, Zurich, Switzerland, pp. 1029-103
[NPL 3]: J. Sumaili, H. Keko, V. Miranda, A. Botterud and J. Wang, “Clustering based wind power scenario reduction technique”, 17th Power Systems Computation Conference, Stockholm Sweden, Aug. 22-26, 2011
[NPL 4]: Nicole Groewe-Kuska, Holger Heitsch and Werner Roemisch, “Scenario Reduction and Scenario Tree Construction for Power Management Problems”, Power Tech Conference Proceedings, 2003 IEEE Bologna (Volume: 3) 23-26 Jun. 2003

### SUMMARY OF INVENTION

### Technical Problem

Uncertainties in predictions of disturbances make the calculation of the optimal operation schedule or optimal real time control actions for a general nonlinear dynamic system difficult. A way to overcome this difficulty is to focus on scenarios which are realizations (samples) of the uncertainties. The difficulty lies in finding a small set of scenarios most relevant for the optimization procedure.

Conventional methods focus on the properties of the scenario itself (scenario tree, scenario clustering methods). They do not consider the effect the prediction scenarios have on the optimization-result of—in the general case—a complex system. However, scenarios distant in some metrics in the scenario describing signal space may lead to optimal commands which are not so distant in the optimal control command space. Additionally, if we consider general scenarios consisting of a scenario describing signals and constraints associated with the scenarios, it is difficult to select the appropriate scenario.

Problem I; If a computation of a solution for a complex uncertain nonlinear dynamic system considering all scenarios—which describe the uncertainty—is considered, it may be too time consuming or even not feasible to carry out this kind of computation considering all scenarios at once. Conventional approximate methods may not lead to the desired level of performance and constraint observance.

Problem II: If the scenarios are reduced by clustering or other techniques just based on the properties of the scenario describing signals themselves, the command space may not be covered. There exist systems where very similar scenarios lead to complete different results (from the command point of view) in the optimization. This may lead to reduced performance and poor observation of the constraints.

Problem III: Linear dynamic system only describes some subset of real life system efficiently. However, they fail for a wide range of system to describe the behavior correctly.

Problem IV: Real time nonlinear predictive control method does not consider different possible scenarios until now because of the computational problem.

### Solution to Problem

The purpose of our invention is to solve problem I. With the invention it becomes possible to treat complex nonlinear dynamic system exposed to uncertainties that can be described with scenarios or an approximate scenario based description can be generated in a way that computing time is reduced and the problem becomes feasible with modern computing architecture. It is achieved by scenario reduction, special optimization criteria and iteration procedure with additional scenario in/excluding and/or constraint relaxing in the case if performance is unsatisfactorily or constraint are too stringent.

Our invention solves problem II by focusing on the solution space comprising all the optimal sequences for each scenario for scenario reduction and the associated optimal performance.

Problem III is solved, since the method can be generally applied and is not necessarily limited to certain system topology.

Problem IV is solved, since the method can reduce in a relevant number of cases the computation time that it can be applied for real time nonlinear predictive control.

The invention relies on a particular procedure to optimize a complex system which is influenced by an uncertainty that can (exactly or approximately) describe with a large set of uncertainties. Its particular feature are the single scenario optimization, the special scenario reduction method, the reduced subset optimization under consideration of the single scenario optimization results, the performance check of solution and measures to improve in the case of infeasibility or poor performance of the calculated solution.

### Effect of Invention

The most important effect of this invention is that the optimization of the operation of complex systems exposed to disturbances, inputs, . . . with significant uncertainties and associated constraints can be achieved with a reduced optimization computing time.

For some complex systems it even means robust optimization becomes possible. Before it was not possible because the needed computing resource was too large for practical use.

In some cases it means, that for such complex systems a model predictive control scheme may become possible.

Therefore, cost/energy consumption/losses or other indexes . . . in operating technical, financial, . . . systems can be reduced by using this method in the Management Systems for optimization.

### BRIEF DESCRIPTION OF DRAWINGS

FIG. 1 Advantage of scenario reduction techniques for scenario based optimization in the case of an efficient criteria for scenario reduction.

FIG. 2 Scenario reduction technique based on the Scenario describing space and the optimization solution space.

FIG. 3 Overall scenario based optimization method with scenario reduction and iteration with scenario subset change and/or constraint relaxation.

FIG. 4 Scenario based MPC (Model predictive control) scheme Using Proposed Method.

FIG. 5 Extreme discretization sampling method for Scenario generation.

FIG. 6 Application 1: Optimal schedule and control of EMS with wind prediction uncertainty and load uncertainty.

FIG. 7 Application 2: BEMS with zonal control and Optimal schedule and control of EMS with wind prediction uncertainty and load uncertainty.

FIG. 8 Scenario obtained from outside temperature prediction.

FIG. 9 Time variant limits for electric power consumption of cooling device.

FIG. 10 Comparing average comfort violations result obtained by single scenario optimization with the method described in this patent.

### DESCRIPTION OF EMBODIMENTS

The present invention (method) is intended for the use in an xManagement System (xMS) (preferably EMS—energy management system, but also others) as part of the optimized command (=action) sequence schedule—and real time optimal command (=action)—computation core of the xMS. The method allows finding optimal command schedules and real time commands regardless of different uncertainties affecting the system to be managed and keep as much as possible the system relevant constraints (e.g. comfort related bounds like temperature, CO2, minimal/maximal air flow, . . . or capital constraints like minimal liquidity, . . . or mechanical, thermal stress, . . . , . . . ) satisfied within a certain degree. Optimality can be related to energy consumption or other criteria (e.g. -max-productivity, -max-quality, -min-discard, -max-profit, . . . ) that required to be either minimized or maximized. The uncertainty is assumed to be described as a large set of scenarios or from the uncertainty description a large set of scenarios can be derived from the uncertainty probabilistic model. A special feature of the invention is that the optimal command sequence or real time command is computed in reasonable time considering the complexity of the task.

Management methods (as realized in electronic management systems) rely for the computation, calculation of the optimal strategy (optimal schedule and optimal real time control command) for optimal operation of the system in most of the cases on predicted parameters/signals.

However, this prediction may contain prediction error or does not lead to just one predicted parameter setting or signal but to a set of possible parameters/signals (set of single values or set of trajectories). In order to improve the achieved result the planned schedule command sequence and real time command should be chosen in a way to achieve good results by taking into account the inherent uncertainty and prediction error.

An example would be an energy management system for a building, where the predicted outside temperature may contain significant prediction error and different possible scenarios for building occupancy and energy use of occupants exist.

The particularity of the method is to allow for an overall comprehensive optimization by a particular procedure to reduce scenarios and carrying out the overall comprehensive optimization with a small set of scenarios which is enlarged in the case, if the predicted results based on this method are of minor quality. The optimization is based on a special optimization criterion.

The invention introduced in this application differs in different aspects:

The invented method differs from Patent Literature 1 (Claim 1 (iii)), as it does not necessarily rely on scenario probability. Major inventive novelty of our patent is the special scenario reduction criteria, and the reduced scenario optimization based approach. Scenario reduction is not mentioned in Patent Literature 1. For complex system (ex. highly nonlinear dynamic system) it is a core step, because for complex system the overall (considering all scenarios) optimization (in Patent Literature 1 called “optimization of coordinating or tracking function”) grows exponentially with the number of scenarios. Additionally, scenario dependent inequality constraints are not mentioned and no solution is described for inequality violation.

The invented method differs clearly from Patent Literature 2 (Claim 1(3), 4(3), 6(3), 7(3), 8(3)), since it does not only consider the outcome (C) of single scenario based optimization runs but also the main selection criterion for scenario selection (reduction) is based on some metrics considering also the associated command sequence (u) and associated performance—“solution space” obtained by single scenario optimization. Furthermore, constraints are stepwise relaxed if necessary in our patent as opposed to the method described in Patent Literature 3 where “risk” constraints are stepwise introduced to fulfil the desired risk level (Claim 1(5)(6), 4(5)(6), 6(6)(7), 7(5)(6), 8(5)(6)).

The invented method differs from Patent Literature 3 (Claim 1)—which also relies on MPC technology and iterative constraint change to fulfill the objective. Patent Literature 3 does not reduce scenarios and hence is not a scenario based MPC approach.

The invented method differs from Patent Literature 4 of the scenario reduction method introduced by the invention described in this application leads also to a clustering of the forecasted scenarios. However, the generation of the clusters is completely different since it is not carried out in the optimization solution space and does not consider the use of forecast values in the optimization.

In Non-Patent Literature 1, the scenario reduction approach (“discard”) is based on a linear parameter variant system. However, the technique is not applicable to a nonlinear dynamic system which occurs often in the management of real world physical systems, . . . .

In Non-Patent Literature 2, the scenario reduction approach (“discard”) is based on a linear system. However, the technique is not applicable to a nonlinear dynamic system which occurs often in the management of energy systems.

In Non-Patent Literature 3, the metrics for scenario reduction is based exclusively on the scenario characterizing signal and does not include the “solution space” obtained from the individual scenario optimization.

In Non-Patent Literature 4, scenarios are reduced by generating the scenario tree and by approximation of the scenario tree with a reduced scenario tree. However, this is based on the parameter/signal uncertainties. It is not said that the all “leafs” of a reduced scenario tree have to be considered in the overall optimization (“Tracking function minimization”). For example, two very different parameter values for two different scenarios lead to almost the same command and therefore, may do not have to be considered in the optimization. It also not considers a verification if results are satisfying and possible iterations.

Introduction

To understand the introduced inventive method, it is important to start with the definition of a scenario. A scenario in this context is described by time sequence(s) of a quantity (-ies) influencing a system and associated time sequence(s) of constraint(s) for this scenario. (System is understood as a very general concept which contains nonlinear dynamic system, but may also include event-driven or hybrid system).

For example, in a building the human occupation of different rooms during a day can be described by time variant variables. The associated temperature constraints for the single rooms are also time variant. (If nobody is in the room, we do not care about the temperature of the room, therefore, the temperature constraints guaranteeing comfort vary over the day).

A scenario would be a concrete realization: occupation time sequences of each room of a specified day plus the associated constraint time sequences for each room for this day. (In this special case, there may be a relation between influencing quantity and constraint, but that is not generally the case and not needed for application of this method).

Scenarios can be the result of a prediction. Prediction sometimes does not lead to one single scenario, but to various possible scenarios. (Ex. If we assume, we do not know what are the possible outcomes when casting a die and a prediction algorithm tells us that 1, 2, 3, 4, 5, 6 are the possible outcomes; then we can say, the prediction lead to a set of 6 possible scenarios).

Method Description

The goal for a Management System (xMS) is to make the best decision considering the different possible scenarios. One way is to include every scenario in the optimization algorithm and find an optimal solution for the “overall” problem. This is only possible for small and not too complex system and a small number of possible scenarios. However, for nonlinear dynamic systems of a certain order and larger number of possible scenarios it is no longer feasible to carry out such an “overall” optimization.

The computation time depends exponentially on the system model order and the number of the scenarios to be considered in the optimization.

Therefore, if it would be possible to cut down heavily the size of considered scenarios (in the optimization process) by keeping deterioration in performance and in constraint fulfillment at a reasonable low level, this would be an important novelty for optimization of uncertain complex system.

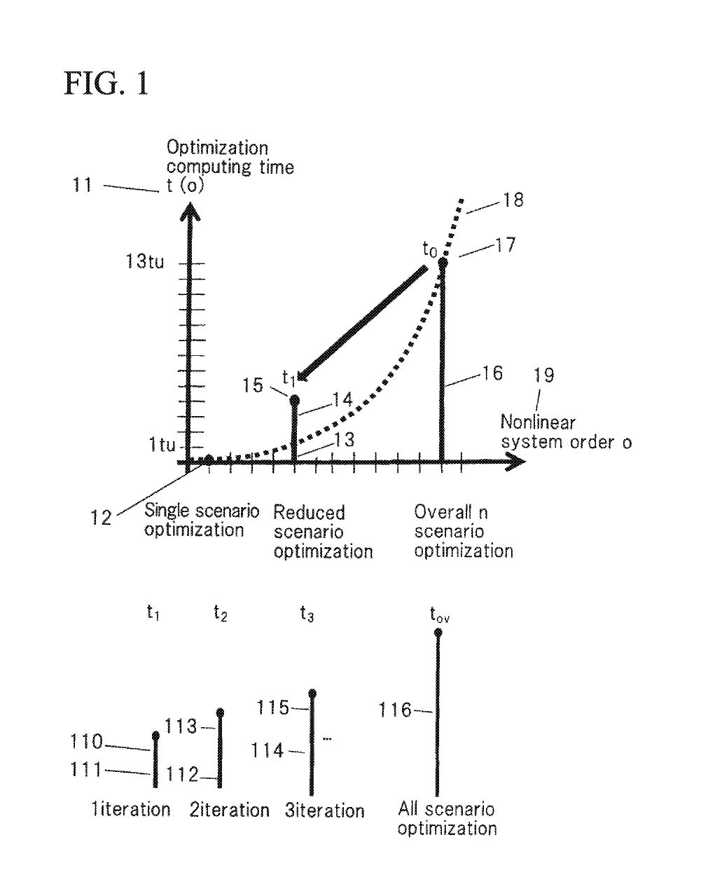

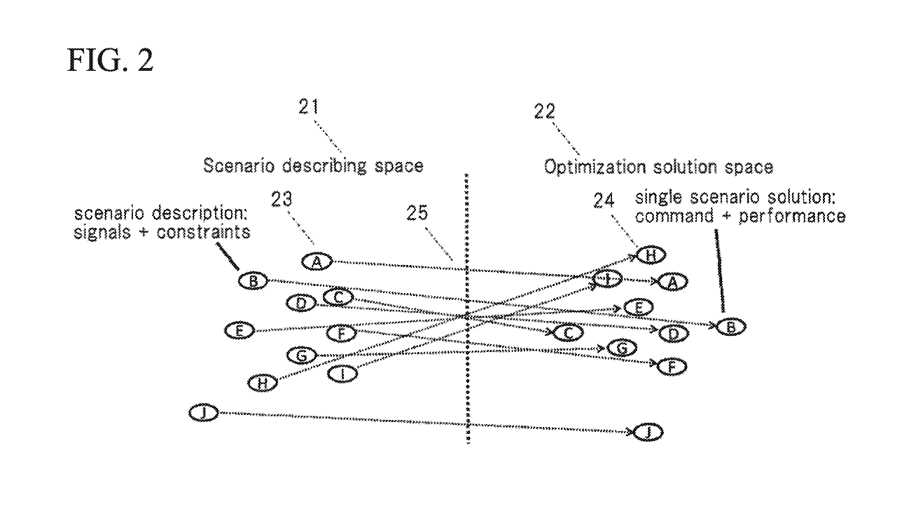

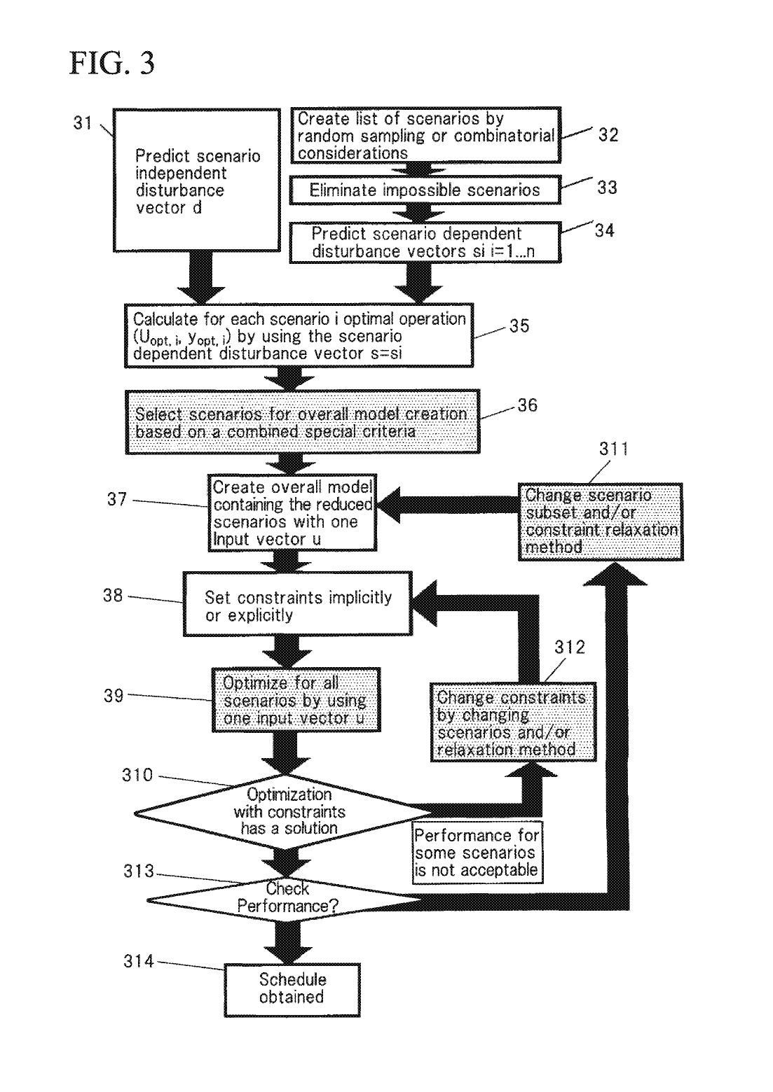

The core of this invention is summarized in FIG. 1 (together with FIGS. 2 and 3) and can be described as following:

Instead of carrying out an expensive (from the computation time perspective) optimization 16 which considers all n scenarios leading to computation time t₀ (17), an optimization is carried out which is based on n single scenarios optimization (12) and an optimization considering a relevant subset (we will see later how this subset is obtained) which leads to the computation time t₁ (15). t₁ (15) is much smaller than to (17). This is due to the fact that for nonlinear/complex/higher order systems the computing time for optimization (optimal command computation time 11) grows exponentially (18) with the nonlinear system order (19). Considering additional scenarios increases the system order since in our definition scenarios contains quantities and associated constraints.

This type of optimization combining single scenario optimization (12) and reduced scenario optimization (14) is only justified if the results are quite as good as the overall scenario optimization (17). However, the results can be evaluated, if it is seemed to be necessary, to include/exclude additional scenarios in order to improve the results.

We want to discuss this in detail: First, we want to see what the costs of this optimization method are. They can be split into the cost (computation tome) arising from carrying out n single scenario optimizations) (14) and the cost of carrying out the reduced scenario optimization+some overhead (coordination, evaluation, . . . ) (13).

If the evaluation of the optimization results leads to an unsatisfactory result, the reduced set optimization can be carried out again with some changed subset of scenarios. In this case the cost of the reduced set optimization rises (111->112) whereas the single scenario optimization cost remains the same (110, 113).

However, as long as they are significantly lower than the overall optimization solution (116) and the results are not too far away from the overall scenario optimization, the advantage of this method persists.

Therefore, it is important to use good criteria for selection of the scenarios for reduced scenario based optimization. The possible criteria for scenario selection are symbolically given in FIG. 2.

As described before, each scenario (ex. 23) is described by quantities and constraints (in the general case time sequences). These quantities are assumed to be given a priori.

So one approach would be to define a criterion in the so called “scenario describing space” (21) for selection of scenarios (ex. What would be the most extreme scenarios in this space by defining some metrics). This selection method has some advantage (it can be implemented at low computational cost), but also some important drawbacks. Generally, this quantities and constraints are not really telling as far as the variance in control system command and system performance is concerned.

Therefore, the proposed invention for scenario selection is based on the so called “optimization-solution space” (22) which contains for each scenario the optimal command and best performance achievable. Either, on the optimization solution space alone or on both spaces, the scenario-describing space (scenario describing quantity plus associated constraints) and the optimization-solution space. By defining appropriate metrics (distances, . . . ) the scenario reduction is carried out.

The computation of the optimal command for a single scenarios (optimization 25) maps the scenario describing signals+constraints in the optimization solution space, where each scenario is characterized with its optimal command and achievable performance (24).

Flow Diagram

In FIG. 3 a flow diagram for the method is shown and will be explained in detail.

At first we show a possible system description for this type of problem. The system could be described with the state evolution equation

\dot{x}=f(x,u,d,dₛ(s)), [Math.1]

the output equation

y=g(x,u,d,dₛ(s)) [Math.2]

and the constraint inequalities and equalities

c(x,u,d,dₛ(s),s)≤0. [Math.3]

In this equation x are the states of the system, u is the inputs or commands of the system, d is the known disturbances, ds are the scenario dependent quantity (-ies), s is the scenario number (integer).

According to FIG. 3 the first step consists in computing the scenario independent disturbance vector d (31). (Ex. In the example of building occupation, we know that one security officer will be the whole day in his room and alone). The step shown in 32 is to create the single scenarios (Sometimes cases arise where the description of the uncertainty affecting the system is not given in terms of scenarios). In this case combinatorial consideration or random sampling can be used to create a high number of scenarios describing the uncertainty situation (distribution) very well. Random sampling may lead to scenarios that are impossible to occur and should be sorted out (33). (Ex. In the example of building occupation: Even if it is highly likely that a single room is fully occupied, it never occurs that all rooms are fully occupied; therefore, this scenario has not to be considered in the optimization).

34 means to derive the scenario describing quantity (-ies) time sequence and associated constraint. Then n optimizations (35) are carried out according to the optimization criteria C to be minimized assumed to be given in beforehand as an operator: C=T(x,u,d,d_{s,y}).

Therefore, n optimal command sequences u_{opt,i}(t) and n performance results C_{opt,i} are available for model selection and overall reduced scenario set based optimization.

For scenario reduction (36) the properties of the optimal command sequences u_{opt,i}(t) of the single scenarios i can be used to determine the scenario that span most of the variation of the command sequence. Different method and metrics can be applied. Also clustering methods like the k-means method can be used. The cluster centers as a result of clustering in the optimization result space could be used in the reduced set for optimization.

The best metrics may be problem dependent. The criterion can include also the constraints and the scenario describing quantity in order to find the most relevant scenarios for optimization.

Step (37) consists in combing the different models resulting from the reduced scenario set (RSS={sᵣ₁, sᵣ₂, sᵣ₃, . . . , sᵣₘ}). So the overall model would look as following:

$$\begin{matrix}[ Math . 4 ] & \\ {\dot{x}}_{1} = f ( {x}_{1} , u , d , {d}_{s} ( {s}_{r 1} ) ) \\ {\dot{x}}_{2} = f ( {x}_{2} , u , d , {d}_{s} ( {s}_{r 2} ) ) \\ ⋮ \\ {\dot{x}}_{m} = f ( {x}_{m} , u , d , {d}_{s} ( {s}_{rm} ) ) \\ {y}_{1} = g ( {x}_{1} , u , d , {d}_{s} ( {s}_{r 1} ) ) \\ {y}_{2} = g ( {x}_{2} , u , d , {d}_{s} ( {s}_{r 2} ) ) \\ ⋮ \\ {y}_{m} = g ( {x}_{m} , u , d , {d}_{s} ( {s}_{rm} ) ) & ( Eq . 2 )\end{matrix}$$

The constraints that have to be considered in the optimization results from all scenarios and are as following:

$$\begin{matrix}[ Math . 5 ] & \\ c ( x , u , d , {d}_{s} ( {s}_{r 1} ) , {s}_{r 1} ) \leq 0 \\ c ( x , u , d , {d}_{s} ( {s}_{r 2} ) , {s}_{r 2} ) \leq 0 \\ ⋮ \\ c ( x , u , d , {d}_{s} ( {s}_{rm} ) , {s}_{rm} ) \leq 0 & ( Eq . 3 )\end{matrix}$$

The constraints can be integrated in the optimization problem in two ways. They can be considered as hard constraints as it is expressed in Eq. 3 or integrated as soft constraints with different weighting for different constraints (38).

The optimization itself (39) needs a criterion. The simplest form of this criterion is to use performance over all original scenarios (n) as criterion. More advanced criteria consider the deviation from the optimal performance as it expressed in the following equation:

$$\begin{matrix}[ Math . 6 ] & \\ {min}_{u ( t ) , t ∈ / {t}_{min} , {t}_{max} /} {‖ \begin{matrix}Δ {C}_{sr 1} \\ ⋮ \\ Δ {C}_{srn}\end{matrix} ‖}_{∞} & \end{matrix}$$

This criterion minimizes the maximal deviation from the optimal operation performance in the single scenario case over the single scenarios

(ΔCₛᵣᵢ=Cₛᵣᵢ−C_{opt,i}). [Math.7]

This problem can be solved by efficient nonlinear dynamic optimization solvers, which are available nowadays.

In the hard constraint case, it may occur that the problem has no solution at all (310). Depending on the optimization algorithm this can be detected at a very early stage. In this case the constraints can be relaxed and/or selection of scenario for optimization changed (some kind of tradeoff of performance for feasibility of a solution) (312).

If the problem is feasible the performance and constraint fulfillment level has to be checked (313). The performance of all scenarios can easily be checked since the single scenario optimal performance is known. Depending on the results, the optimization is finished in the case of satisfactory results. Otherwise scenarios have to be excluded/included in the scenario subset for optimization and/or constraints relaxed (311).

Scenario Based MPC (Model Predictive Control)

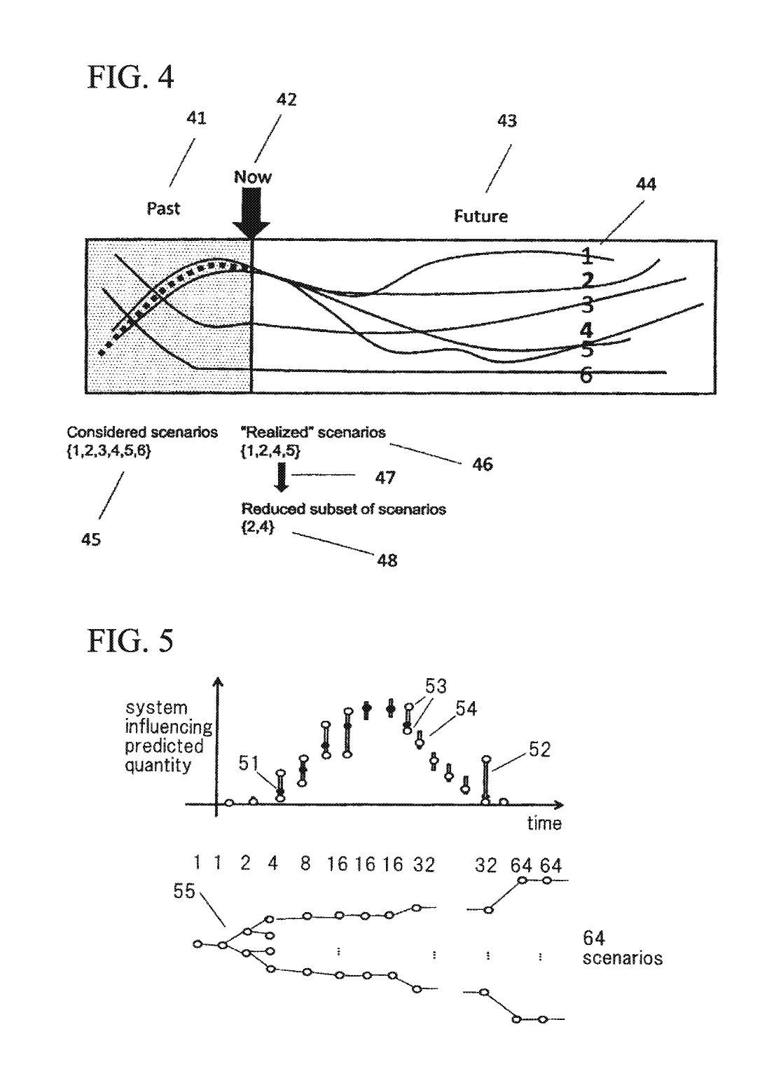

The introduced optimization procedure by this patent can be used in the optimization part of model predictive control scheme working in an uncertain environment described with scenarios. In FIG. 4, the idea is given by showing a small example:

The scenarios 1, 2, 3, 4, 5, 6 (45) (shown are the scenario describing quantity signals (44), constraints are omitted in this figure) are predicted. The situation in FIG. 4 is that some time has already past (41) and the controller has to choose which scenarios to include in the optimization since all scenarios are too expensive to compute. At the time instant the controller takes the decision (42), two scenarios 3, 6 can be excluded without any special method, because the scenarios are very unlikely to have realized themselves, since the deviation from the measured signal is too large, but 4 scenarios (46) 1, 2, 4, 5 have high probability since they are “compatible with the past” (41) (the dotted line is the measured signal, it is only available until now). The subset consisting of scenario 1, 2, 4, 5 should be reduced more in order to reduce computation time. The method introduced in this patent is used. As a result, the scenario subset is reduced to the size of 2 scenarios (48) by the special scenario reduction technique (47).

If we assume a quadratic dependence of the computing time for the optimization on the system order, it would mean to reduce the total optimization time to 12 time units instead of 16 time units (in the case that a single scenario optimization takes 1 time unit).

The examples in this patent use small number of scenarios. However, to describe uncertainties with an appropriate accuracy to reflect the statistic and stochastic structure correctly a high number of scenarios have to be considered. In this case the advantage of the method introduced in this patent with its special scenario reduction technique is even higher.

Extreme Discretization Sampling for Scenario Generation

In order to use this methodology for applications where the prediction is not based on scenario but on a predicted quantity plus the indication of possibly time variant error bounds, a so called radical sampling strategy is used. In FIG. 5, an example is given.

Using this method each value (51) with error bounds (52) is substituted with two (53) (or three, but ideally a very low number) possible values, if the confidence interval described by the error bounds is larger than some threshold value, otherwise just one value (the mean value) is used (54). (55) shows the signal related scenario tree. In the example 64 scenario are generated by extreme discretization for further consideration in the optimization method as introduced by this invention.

Two application examples are given for this invention:

The first example is the energy management system (66) as shown in FIG. 6 for the operation of an energy system consisting of a Wind farm (63), an energy storage (65), variable loads (62) and grid access (64). Cost, grid peak power, . . . should be reduced as much as possible by using dynamic optimization. However, the wind prediction (61) is uncertain. The wind prediction algorithm leads to a number of possible occurring r power sequences (r wind power scenarios) generated by the wind power plant. The load (demand) (62) can be predicted, but the prediction has some error described by confidence intervals. In this application the load uncertainty can be discretized by the extreme discretization method as described before and lead to t possible load scenarios. Therefore, the resulting overall scenario number is m=r*t, which could be a very high number. In order to compute the optimal operation of the battery (charge/discharge power) the invented method of this patent can be used in order to solve the problem with reasonable computational cost.

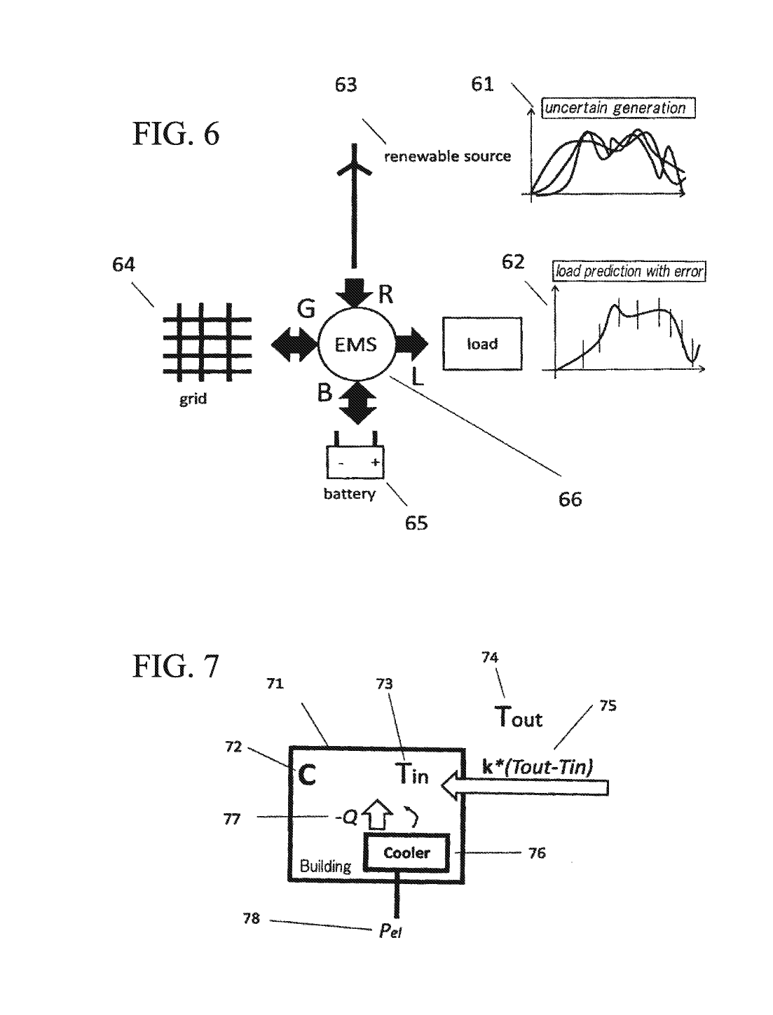

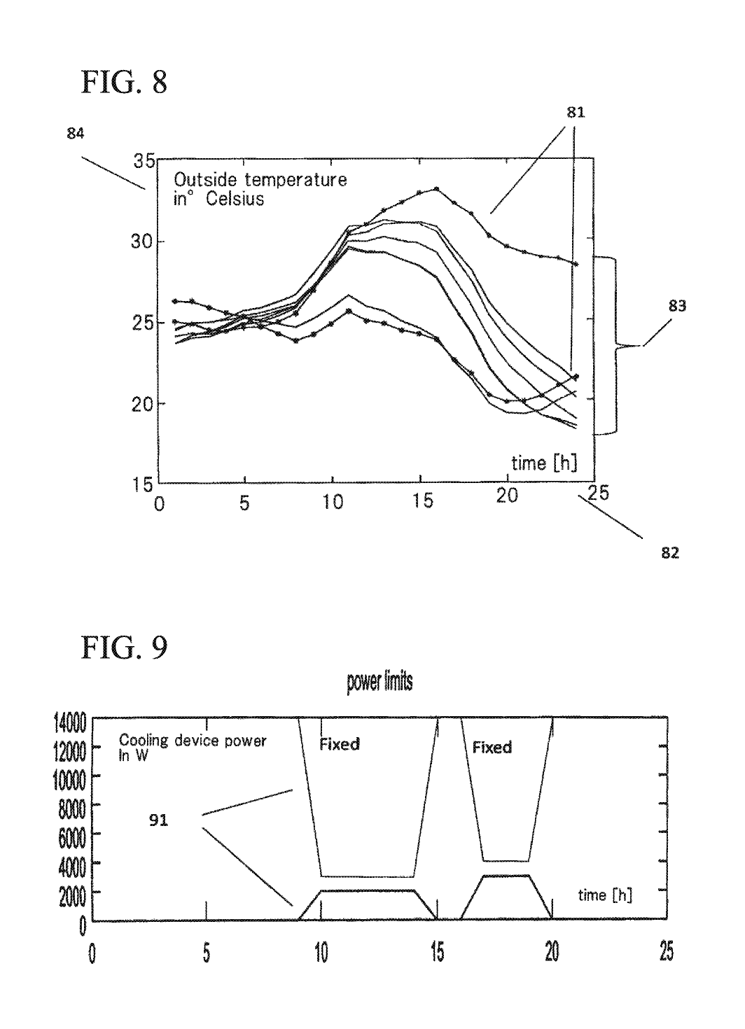

The second example is given as an Energy management system as shown in FIG. 7 for a building thermal control (71), where the outside temperature prediction (FIG. 8) is uncertain. A cooling device can be controlled by changing the electric power (78) supplied to the device. The inside temperature (73) should be kept in a comfortable band during the day. The building thermal properties can be described with the heat capacity of the building C (72) and a constant describing the heat conductance k from outside to inside the building (75).

The task of the energy management system is to find an operation schedule of the cooling device that guarantees observance of the inside temperature bounds for comfort of the occupant, realizes some Demand Response task (constraints) as shown in FIG. 9 and minimize the electric energy consumption of the device over one day.

The Demand Response task leads to the constraints that limit the power of the cooling device during 10:00-14:00 and 17:00-19:00 in a narrow range (91).

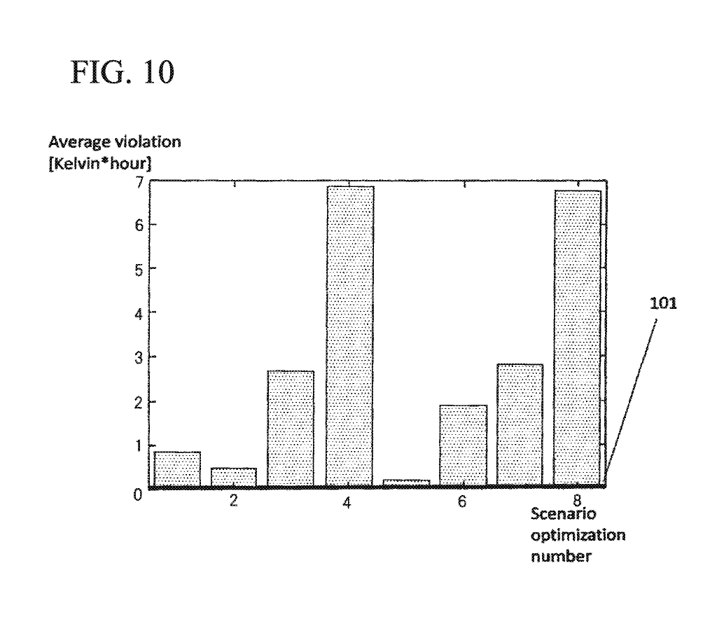

The optimization carried out according to this method (FIG. 1, FIG. 3, FIG. 2) leads to the results as seen in FIG. 10. Instead making an optimization based on all scenarios (83). Single scenario optimization has been used together with reduced scenario subset (81) optimization. The result in constraint satisfaction is shown in FIG. 10. It is shown that the method leads to a very small number in mean comfort violation (101) compared to the expected value obtained by single scenario optimization and check the performance with all possible scenarios of the single scenario optimization result (columns).

This is obtained without an expensive overall scenario optimization (in this case there are 8 scenarios: if we assume computation time grows quadratic with order then it means that 8̂2=64 time units in the case of overall classic optimization. In the case of the invention 8*1+1*2̂2=12 time units are needed, which is a drastic reduction).

The present invention has been described by referring to an exemplary embodiment. However, the present invention is not limited to the above-described exemplary embodiment. Various changes understandable by those skilled in the art in the scope of the present invention can be made in the configuration and details of the present invention.

### INDUSTRIAL APPLICABILITY

The invention can be used for energy management system and management- and real time-control systems generally. It can be used in scheduling, planning and real time predictive control as well.

So it could be used in the process industry and EMS systems industry, which is quite a large field for application. Since it is a method it basically could be used in different management system, such as financial management, . . . as well.

### REFERENCE SIGNS LIST

11 Computing time for optimization
12 Result for single scenario optimization (needed computing time)
13 Contribution of scenario subset optimization plus overhead (computing time)
14 Contribution of n single scenario optimization (computing time)
15 Total time for reduced scenario subset and single scenario based novel optimization method
16 Computing time for overall scenario based optimization
17 Computing time for overall scenario based optimization
18 Computing time dependent on model order characteristics
19 Nonlinear system order o
110 Contribution of n single scenario optimizations
111 Contribution of reduced scenario optimization considering 1 iterations
112 Contribution of reduced scenario optimization considering 2 iterations
113 Contribution of n single scenario optimizations
114 Contribution of reduced scenario optimization considering 3 iterations
115 Contribution of n single scenario optimizations
116 Computing time for overall scenario based optimization
21 Scenario describing space
22 Optimization solution space
23 Single scenario position in the scenario describing space
24 Single scenario position in the optimization solution space
25 Mapping from one space to the other by single scenario based optimization
31 Prediction of scenario independent disturbance vector d
32 Scenario generation by sampling or other methods
33 Elimination of impossible scenarios
34 Prediction of scenario related quantities and constraints (time sequences)
35 Single scenario optimization
36 Scenario selection (=reduction) procedure
37 Subset overall model generation
38 Constraints setting (hard/soft, explicit/implicit)
39 Reduced scenarios based optimization
310 Feasibility check
311 Scenario in/exclusion and/or constraint relaxation
312 Scenario changing and/or constraint relaxation
313 Performance check
314 Successful completion of optimization procedure
41 Past (time before the current instant)
42 Current time instant at which the MPC controller has to calculate its action
43 Future development of signals (after the current instant)
44 Signals characterizing the single scenarios
45 Set of scenarios to consider
46 Set of scenarios relevant considering the past
47 Scenario reduction method
48 Set of scenarios for reduced scenarios based combined optimization
51 Predicted mean value of quantity at a certain time instant
52 Confidence interval of prediction error at a certain time instant
53 Replacement of uncertainty by two possible realizations at a certain time instant
54 Replacement of uncertainty by one possible realization at a certain time instant
55 Signal scenario tree
61 Set of predicted scenarios for wind power generation
62 Predicted demand (load) with error bounds (confidence intervals)
63 Wind power plant
64 Grid supply
65 Energy storage (battery)
66 Energy Management System (EMS)
71 Building
72 Heat capacity C of the building
73 Building inside temperature
74 Outside air temperature
75 Heat-flow from outside to inside
76 Cooler device
77 Cooling power released to building
78 Electrical power consumed by the cooler
81 Subset of scenarios (2 scenarios) obtained by scenario reduction method
82 Time axis (in hours)
83 Overall scenarios (obtained from prediction or by sampling the statistical structure of
the outside temperature for this day)
84 Temperature axis in Celsius
91 Limiting bounds for electric power consumption of cooling device
101 Achieved average temperature violation (averaged over all scenarios) in Kelvin hours
[Kh] by the method described in this patent

What is claimed is:

1. A method of a scenario based optimization, comprising:
a scenario generation step that generates single scenarios which are described by time sequence of quantities influencing a system and by time sequence of constraints for the system;
a single optimization step that carries out optimization of each single scenarios; and
an overall optimization step that carries out optimization of an overall scenario using a reduced scenario set which contains scenario subsets that are selected from all single scenarios based on the results of the single optimization step with/without considering the properties of the scenarios itself.

2. The method according to claim 1, wherein the overall optimization step includes a scenario reduction step for selecting the scenario subsets based on the impact in command sequences of the single scenarios.

3. The method according to claim 2, wherein the scenario reduction step takes into consideration the performance results of the single scenarios obtained by the single optimization step.

4. The method according to claim 2, wherein the scenario reduction step finds a set of the most extreme scenarios by using metrics.

5. The method according to claim 2, wherein the scenario reduction step finds a set of cluster centers by clustering the command sequences according to problem-specific or general rules.

6. The method according to claim 1 further comprising:
an iteration step that iterates the overall optimization step with scenario subsets that is changed if the overall scenario performance results are not acceptable.

7. The method according to claim 6, wherein the iteration step includes relaxing constraints in case the reduced scenario set optimization is not feasible.

8. The method according to claim 1, wherein the overall optimization step uses a criterion which minimizes the maximal deviation of single scenario optimal results in the overall optimization.

9. The method according to claim 1, wherein the scenario creation step uses an extreme discretization technique for single scenario generation.

10. The method according to claim 1 applied during the optimization process for real time model predictive control (MPC).
